(19) United States
(12) Patent Application Publication
(10) Pub. No.: US 2025/0263530 A1
(43) Pub. Date: Aug. 21, 2025

(54) HFCO-CONTAINING ISOCYANATE-REACTIVE COMPOSITIONS, POLYURETHANE FOAMS FORMED THEREFROM, AND COMPOSITE ARTICLES INCLUDING SUCH FOAMS

(71) Applicant: Covestro LLC, Pittsburgh, PA (US)

(72) Inventors: Michael H. Bell, McMurray, PA (US); Jason D. Steranko, Wexford, PA (US); Shawn G. Rider, Harrisville, PA (US); Brandon W. Parks, McKees Rocks, PA (US)

(21) Appl. No.: 19/034,953

(22) Filed: Jan. 23, 2025

Related U.S. Application Data
(60) Provisional application No. 63/553,817, filed on Feb. 15, 2024.

(51) Int. Cl. C08J 9/14; C08G 18/48; C08G 18/76; C08J 9/08

(52) U.S. Cl. CPC C08J 9/147; C08G 18/482; C08G 18/7657; C08J 9/08; C08G 2110/0025; C08J 2203/02; C08J 2203/142; C08J 2205/10; C08J 2375/04

(57) ABSTRACT

Isocyanate-reactive compositions, polyurethane foam-forming compositions, rigid polyurethane foams, and methods for their production, and composite articles comprising such foams sandwiched between metal facer substrates. The rigid polyurethane foams are produced using a hydrochlorofluoroolefin (“HCFO”) physical blowing agent and can exhibit a combination of properties suitable for use in the production of discontinuous panel insulation, such as the production of insulated entry doors. The foams may exhibit thermal insulation properties similar to comparable foams suitable for use in such applications, while utilizing significantly reduced amounts of HCFO.

### FIELD

This specification pertains generally to isocyanate-reactive compositions, rigid polyurethane foam-forming compositions, rigid polyurethane foams, and methods for their production, as well as to composite articles comprising such foams sandwiched between facer substrates. The rigid polyurethane foams are produced using a hydrochlorofluoroolefin (“HCFO”) physical blowing agent and can exhibit properties suitable for use in the production of discontinuous panel insulation, such as the production of insulated entry doors. Moreover, it is believed that such foams can exhibit thermal insulation properties similar to comparable foams suitable for use in such applications, while utilizing significantly reduced amounts of HCFO.

### BACKGROUND

Rigid polyurethane foams are used in numerous industries and are produced by reacting a polyisocyanate and an isocyanate-reactive compound, usually a polyol, in the presence of a blowing agent. One use of such foams is as a thermal insulation medium in the construction of entry doors for buildings. The thermal insulating properties of closed-cell rigid foams are dependent upon a number of factors, including the average cell size and the thermal conductivity of the contents of the cells. As a result, fluorocarbons were historically used as blowing agents in such foams because of their low thermal conductivity. Fluorocarbons, however, including chlorofluorocarbons (“CFCs”), hydrofluorocarbons (“HFCs”) and hydrochlorofluorocarbons (“HCFCs”), are greenhouse gases that have been phased out of use. Halogenated olefins, such as HCFOs, are environmentally friendlier alternatives for such fluorocarbons, but they can be costly. As a result, it is desirable to identify ways to significantly reduce the amount of HCFOs needed in a formulation for producing a rigid polyurethane foam, provided that the thermal efficiency of the resulting foam is not detrimentally impacted to any significant extent.

Formulations used to produce such thermally insulating rigid polyurethane foam often utilize catalysts to control the relative rates of water-polyisocyanate (gas-forming or blowing) reaction and the polyol-polyisocyanate (gelling) reaction. In the gelling reaction, the isocyanate reacts with polyols to form the polyurethane foam matrix. In the blowing reaction, the isocyanate reacts with water in the formulation to form polyurea and carbon dioxide. While these reactions take place at different rates, it is necessary to properly balance them to produce high-quality foam. For example, it can be necessary to maintain a high blow to gel reaction ratio, so that the gel reaction does not occur too quickly, otherwise the foam may exhibit shrinkage and poorer physical properties, such as thermal insulation, and adhesion properties. As a result, reducing the amount of HCFO blowing agent (physical blowing) used in the formulation can enable also the reduction in the amount of gel catalyst used, while maintaining a desired high blow reaction to gel reaction rate ratio.

In view of the foregoing, it would be desirable to provide compositions that can be used to produce polyurethane foams with properties suitable for use in the production of discontinuous panel insulation, while utilizing a significantly reduced amount of HCFO blowing agent.

### SUMMARY

In certain respects, the present disclosure is directed to isocyanate-reactive compositions that comprise: (a) a polyol blend comprising 1 to 20% by weight, based on the total weight of the polyol blend, of an alkanolamine-initiated polyether polyol having an OH number of at least 500 mg KOH/g polyol and a functionality of 2.5 to 4, wherein the polyol blend has a content of —C₂H₄O— units of 2 to 15% by weight, based on the total weight of the isocyanate-reactive composition; (b) a blowing agent composition; and (c) a catalyst composition comprising a tertiary amine. The blowing agent composition comprises (1) a physical blowing agent; and (2) a carbon dioxide-generating chemical blowing agent, in which (i) the chemical blowing agent is present in an amount of 3 to 6% by weight, based on the total weight of the polyol blend, (ii) the physical blowing agent comprises a hydrochlorofluoroolefin that is present in an amount of 4 to less than 12% by weight, based on total weight of the polyol blend, and in an amount of at least 80% by weight, based on total weight of the physical blowing agent present in the blowing agent composition, and (iii) the physical blowing agent and the chemical blowing agent are present in a relative ratio, by weight, of 1:1 to 3:1.

In other respects, the present disclosure is directed to isocyanate-reactive compositions that comprise: (a) a polyol blend comprising 1 to 20% by weight, based on the total weight of the polyol blend, of an alkanolamine-initiated polyether polyol having an OH number of at least 500 mg KOH/g polyol and a functionality of 2.5 to 4, wherein the polyol blend has a content of —C₂H₄O— units of 2 to 15% by weight, based on the total weight of the isocyanate-reactive composition; (b) a blowing agent composition comprising (1) a HCFO; and (2) a carbon dioxide-generating chemical blowing agent; and (c) a catalyst composition comprising an arylalkyl tertiary amine, an aryl tertiary amine, or a mixture thereof that is present in an amount of 0.1 to less than 1.0% by weight, based on the total weight of the polyol blend.

The present specification is also directed to rigid polyurethane foams produced from such compositions and methods for making such rigid polyurethane foams, as well as to composite articles that include such foams sandwiched between a first substrate and a second substrate.

### BRIEF DESCRIPTION OF THE DRAWING

Various features and characteristics of the inventions described in this specification may be better understood by reference to the accompanying FIGURE, in which:

FIG. 1 is a schematic illustration of a cross-section of a composite article according to certain implementations.

### DETAILED DESCRIPTION

Various embodiments are described and illustrated in this specification to provide an overall understanding of the structure, function, properties, and use of the disclosed inventions. It is understood that the various embodiments described and illustrated in this specification are non-limiting and non-exhaustive. Thus, the invention is not limited by the description of the various non-limiting and non-exhaustive embodiments disclosed in this specification. The features and characteristics described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. Therefore, any such amendments comply with the requirements of 35 U.S.C. § 112 and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant(s) reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112 and 35 U.S.C. § 132(a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used herein, the term “functionality” refers to the average number of reactive hydroxyl groups, —OH, present per molecule of the polyol or polyol blend that is being described. In the production of polyurethane foams, the hydroxyl groups react with isocyanate groups, —NCO, that are attached to a polyisocyanate. The term “hydroxyl number” refers to the number of reactive hydroxyl groups available for reaction, and is expressed as the number of milligrams of potassium hydroxide equivalent to the hydroxyl content of one gram of the polyol (ASTM D4274-16). The term “equivalent weight” refers to the weight of a compound divided by its valence. For a polyol, the equivalent weight is the weight of the polyol that will combine with an isocyanate group, and may be calculated by dividing the molecular weight of the polyol by its functionality. The equivalent weight of a polyol may also be calculated by dividing 56,100 by the hydroxyl number of the polyol—Equivalent Weight(g/eq)=(56.1×1000)/OH number.

The polyol blends described in this specification have a content of —C₂H₄O— units within a specified range. As used in this context, “a content of —C₂H₄O— units” refers to the calculated weight of —C₂H₄O— units present in a polyol that are formed during production of the polyol itself (as opposed to —C₂H₄O— units that may already be present in a reactant used to prepare the polyol). In the case of a polyether polyol that is an alkoxylation reaction product of an H-functional starter and an alkylene oxide, for example, —C₂H₄O— units can result from use of ethylene oxide as an alkylene oxide and/or use of an H-functional starter containing a —C₂H₄Z— group in which Z represents a Zerewitinoff-active hydrogen atom (also referred to merely as “active hydrogen”), such as can be the case where Z represents a hydrogen bonded to N, O or S. In the case of a polyester polyol that is a reaction product of a carboxylic acid and/or anhydride thereof with a hydroxyl-containing material, —C₂H₄Z— units may result, for example, from use of diethylene glycol as a hydroxyl-containing material. Thus, when it is stated herein that a polyol blend has a content of —C₂H₄O— units of 1 to 6% by weight, based on total weight of a reaction mixture, it means that 1 to 6% by weight of the reaction mixture, based on the total weight of the reaction mixture, is —C₂H₄O— units formed during production of the polyol(s) that are present in the reaction mixture, as calculated based on the weight of materials used to make the polyols.

In certain implementations, this specification is directed to producing rigid foams. A rigid foam is characterized as having a ratio of compressive strength to tensile strength of at least 0.5:1, elongation of less than 10%, as well as a low recovery rate from distortion and a low elastic limit, as described in in “Polyurethanes: Chemistry and Technology, Part II Technology,” J. H. Saunders & K. C. Frisch, Interscience Publishers, 1964, page 239.

In some implementations, this specification is directed to isocyanate-reactive compositions that comprise a polyol blend. More specifically, the polyol blend of the isocyanate-reactive compositions of this specification comprises an alkanolamine-initiated polyether polyol. As used herein, “alkanolamine-initiated polyether polyol” refers to a polyether polyol prepared by reacting at least one alkylene oxide with one or more suitable H-functional initiator compounds in the presence of a suitable catalyst, in which the initiator compounds comprise one or more alkanolamines in which alkanolamine is used in an amount of at least 50% by weight, based on the total weight of H-functional initiator that is used to prepare the polyether polyol. Suitable catalysts including basic catalysts (such as sodium or potassium hydroxide or tertiary amines such as methyl imidazole) and DMC catalysts. In the polyol blends described herein, each of the recited polyether polyols, including the “alkanolamine-initiated polyether polyol” are different from each other. In some implementations, the initiator compound used to prepare the alkanolamine-initiated polyether polyol consists essentially of, or consists of, an alkanolamine. As used herein, “consists essentially of”, when used with reference to the content of alkanolamine used to prepare the alkanolamine-initiated polyether polyol, means that alkanolamine is used in an amount of at least 80% by weight, at least 90% by weight, or, in some cases, at least 95% by weight, based on the total weight of H-functional initiator oxide used to prepare the alkanolamine-initiated polyether polyol. In some implementations, alkanolamine is the only H-functional initiator used to prepare the alkanolamine-initiated polyether polyol.

As used herein, the term “alkanolamine” refers to compounds represented by the formula:

NH₂—Z—OH

in which Z represents a divalent radical which is a straight chain or branched chain alkylene radical having 2 to 6 carbon atoms, a cycloalkylene radical having 4 to 6 carbon atoms or a dialkylene ether radical having 4 to 6 carbon atoms. The dialkylene ether radical may be represented by the formula:

R—O—R—

where each R represents a hydrocarbon radical having 2 to 3 carbon atoms.

Specific examples of suitable alkanolamines that may be used in the preparation of the alkanolamine-initiated polyether polyol include monoethanolamine, 1-amino-2-propanol, 2-amino-1-propanol, 3-amino-1-propanol, 1-(2-aminoethoxy) ethanol, 1-amino-2-butanol, 2-amino-3-butanol, 2-amino-2-methylpropanol, 5-amino pentanol, 3-amino-2, 2-dimethyl propanol, 4-aminocyclohexanol, as well as mixtures of any two or more thereof.

To prepare the alkanolamine-initiated polyether polyol, the alkanolamine is reacted with an alkylene oxide. Suitable alkylene oxides include ethylene oxide, propylene oxide, butylene oxide, styrene oxide, and epichlorohydrin, as well as mixtures of any two or more thereof. In some implementations, the alkylene oxide consists essentially of, or consists of, propylene oxide. As used herein, “consists essentially of”, when used with reference to the content of propylene oxide used to prepare the alkanolamine-initiated polyether polyol, means that propylene oxide is used in an amount of at least 80% by weight, at least 90% by weight, or, in some cases, at least 95% by weight, based on the total weight of alkylene oxide used to prepare the alkanolamine-initiated polyether polyol. In some cases, propylene oxide is the only alkylene oxide used to prepare the alkanolamine-initiated polyether polyol.

In some implementations, the alkanolamine-initiated polyether polyol, has an OH number of at least 500 mg KOH/g polyol, such as 500 to 900 mg KOH/g polyol, 600 to 800 mg KOH/g polyol, or, in some cases, 680 to 720 mg KOH/g polyol, and a functionality of 2.5 to 4, such as 2.5 to 3.5.

Moreover, in the isocyanate-reactive compositions of this specification, the alkanolamine-initiated polyether polyol is present in an amount of 1 to 20%, such as 5 to 20% by weight, 10 to 20% by weight, or 10 to 15% by weight, based upon the total weight of the polyol blend.

The polyol blend comprises one or more additional polyols. For example, in some implementations, the polyol blend comprises a saccharide-initiated polyether polyol that is different from the previously described alkanolamine-initiated polyether polyol. As used herein, “saccharide-initiated polyether polyol” refers to a polyether polyol prepared by reacting at least one alkylene oxide with one or more suitable H-functional initiator compounds in the presence of a suitable catalyst, in which the H-functional initiator compound comprises one or more saccharides, in which saccharide is used in an amount of at least 50% by weight, such as 50 to 90% by weight, based on the total weight of H-functional initiator that is used to prepare the polyether polyol. Some examples of suitable saccharide initiators are sucrose, sorbitol, maltitol, and mixtures thereof, as well as other mono-saccharides, di-saccharides, tri-saccharides and polysaccharides. Other initiator compounds are often used in combination with the saccharide initiator to prepare the saccharide-initiated polyether polyol. Saccharides can be co-initiated with for example, compounds such as water, propylene glycol, glycerin, ethylene glycol, ethanol amines, diethylene glycol, or a mixture of any two or more thereof, to form a saccharide-initiated polyether polyol.

Suitable alkylene oxides for use in preparing the saccharide-initiated polyether polyol include ethylene oxide, propylene oxide, butylene oxide, styrene oxide, and epichlorohydrin, as well as mixtures of any two or more thereof. In some implementations, however, the alkylene oxide consists essentially of, or consists of, propylene oxide. As used herein, “consists essentially of”, when used with reference to the content of propylene oxide used to prepare the saccharide-initiated polyether polyol, means that propylene oxide is used in an amount of greater than 80% by weight, at least 90% by weight, or, in some cases, at least 95% by weight, based on the total weight of alkylene oxide used to prepare the saccharide-initiated polyether polyol. In some implementations, propylene oxide is the only alkylene oxide used to prepare the saccharide-initiated polyether polyol. In other implementations, however, propylene oxide is used in an amount of 50 to 80% by weight, such as 60 to 80% by weight, or, in some cases 65 to 75% by weight, based on the total weight of alkylene oxide used to prepared the saccharide-initiated polyether polyol, and ethylene oxide in used in an amount of 10 to 50% by weight, such as 20 to 40% by weight, or, in some cases, 25 to 35% by weight, based on the total weight of alkylene oxide used to prepare the saccharide-initiated polyether polyol. In some cases, the saccharide-initiated polyether polyol comprises: (i) a first saccharide-initiated polyether polyol in which propylene oxide is used in an amount of greater than 80% by weight, at least 90% by weight, or, in some cases, at least 95% by weight, or 100% by weight, based on the total weight of alkylene oxide used to prepare the first saccharide-initiated polyether polyol, and (ii) a second saccharide-initiated polyether polyol in which propylene oxide is used in an amount of 50 to 80% by weight, 60 to 80% by weight, or 65 to 75% by weight, based on the total weight of alkylene oxide used to prepare the second saccharide-initiated polyether polyol, and ethylene oxide in used in an amount of 10 to 50% by weight, 20 to 40% by weight, or 25 to 35% by weight, based on the total weight of alkylene oxide used to prepare the second saccharide-initiated polyether polyol.

Some examples of suitable catalysts which can be used include basic catalysts (such as sodium or potassium hydroxide or tertiary amines such as methyl imidazole), and double metal cyanide (DMC) catalysts.

In some embodiments, the saccharide-initiated polyether polyol has an OH number of 200 to 600 mg KOH/g polyol, such as 300 to 550 mg KOH/g polyol, or 400 to 500 mg KOH/g polyol, and a functionality of 4 to 6. In some more specific implementations, the saccharide-initiated polyether polyol comprises: (i) a first saccharide-initiated polyether polyol (as described above) with an OH number of 200 to 600 mg KOH/g polyol, 300 to 500 mg KOH/g polyol, or 400 to 450 mg KOH/g polyol, and a functionality of 4 to 6, 4 to 5, or 4.0 to 4.5, and (ii) a second saccharide-initiated polyether polyol (as described above) with an OH number of 200 to 600 mg KOH/g polyol, 300 to 500 mg KOH/g polyol, or greater than 450 to 500 mg KOH/g polyol, and a functionality of 4 to 6, 5 to 6, or 5.2 to 5.8.

In some embodiments, the saccharide-initiated polyether polyol is present in an amount of 50 to 90% by weight, such as 60 to 80% by weight, or 65 to 75% by weight, based on the total weight of the polyol blend. In some more specific implementations, the saccharide-initiated polyether polyol comprises: (i) a first saccharide-initiated polyether polyol (as described above) that is present in an amount of 10 to 40% by weight, such as 20 to 30% by weight, based on total weight of the polyol blend, and (ii) a second saccharide-initiated polyether polyol (as described above) that is present in amount of 30 to 80% by weight, 30 to 60% by weight, 30 to 50% by weight, or 40 to 50% by weight, based on total weight of the polyol blend. In some embodiments, the second saccharide-initiated polyether polyol and the first saccharide-initiated polyether polyol are present in a relative ratio, by weight, of 1:1 to 3:1, such as 1:1 to 2:1, or 1.5:1 to 2:1.

In some implementations, the polyol blend comprises an aliphatic triol-initiated polyether polyol that is different from the any of the previously described polyether polyols. As used herein, “aliphatic triol-initiated polyether polyol” refers to a polyether polyol prepared by reacting at least one alkylene oxide with one or more suitable H-functional initiator compounds in the presence of a suitable catalyst, in which the H-functional initiator compound comprise an aliphatic triol, in which aliphatic triol is used in an amount of at least 50% by weight, based on the total weight of H-functional initiator that is used to prepare the polyether polyol. In some implementations, aliphatic triol is used in an amount of 50% to 100% by weight, such as 80 to 100% by weight, 90 to 100% by weight, or 100% by weight, based on the total weight of H-functional initiator used to prepare the aliphatic triol-initiated polyether polyol. Glycerin is an example of an aliphatic triol H-functional initiator compound. Other initiator compounds may be used in combination with the aliphatic triol initiator to prepare the aliphatic triol-initiated polyether polyol, such as any of the saccharides mentioned earlier, water, propylene glycol, ethylene glycol, ethanol amines, diethylene glycol, or a mixture of any two or more thereof.

Suitable alkylene oxides for use in preparing the aliphatic triol-initiated polyether polyol include ethylene oxide, propylene oxide, butylene oxide, styrene oxide, and epichlorohydrin, as well as mixtures of any two or more thereof. In some implementations, however, the alkylene oxide consists essentially of, or consists of, propylene oxide. As used herein, “consists essentially of”, when used with reference to the content of propylene oxide used to prepare the aliphatic triol-initiated polyether polyol, means that propylene oxide is used in an amount of greater than 80% by weight, at least 90% by weight, or, in some cases, at least 95% by weight, based on the total weight of alkylene oxide used to prepare the aliphatic triol-initiated polyether polyol. In some implementations, propylene oxide is the only alkylene oxide used to prepare the aliphatic triol-initiated polyether polyol.

Some examples of suitable catalysts which can be used include basic catalysts (such as sodium or potassium hydroxide or tertiary amines such as methyl imidazole), and double metal cyanide (DMC) catalysts.

In some embodiments, the aliphatic triol-initiated polyether polyol has a hydroxyl number of 200 to 800 mg KOH/g polyol, 300 to 600 mg KOH/g polyol, 400 to 500 mg KOH/g polyol, or 450 to 500 mg KOH/g polyol, and a functionality of greater than 2 to less than 4, 2.5 to 3.5, or 3.0.

In certain embodiments, the aliphatic triol-initiated polyether polyol is present in an amount of 10 to 50% by weight, such as 10 to 40% by weight, or 10 to 30% by weight, or 15 to 25% by weight, based on the total weight of the polyol blend.

In certain embodiments, the polyol blend comprises both a saccharide-initiated polyether polyol as described above and an aliphatic triol-initiated polyether polyol as described above, in which saccharide-initiated polyether polyol and aliphatic triol-initiated polyether polyol are present in the polyol blend in a weight ratio of 1:10 to 10:1, such as 1:1 to 10:1, 1:1 to 5:1, or 2:1 to 4:1.

In some implementations, the polyol blend comprises a saccharide-initiated polyether polyol as described above, in which saccharide-initiated polyether polyol and alkanolamine-initiated polyether polyol are present in the polyol blend at a weight ratio of at least 1:1, such as 1:1 to 10:1, or 2:1 to 8:1; 4:1 to 8:1 or 5:1 to 6:1. In some implementations, the polyol blend comprises an aliphatic triol-initiated polyether polyol as described above, in which aliphatic triol-initiated polyether polyol and alkanolamine-initiated polyether polyol are present in the polyol blend at a weight ratio of at least 1:1, such as 1:1 to 10:1, or 1:1 to 5:1; 1:1 to 2:1 or 1.2:1 to 1.8.1.

The polyol blend may comprise any of a variety of other polyols and may, if desired, include other compounds with isocyanate-reactive groups, such as chain extenders and/or crosslinking agents, and higher molecular weight polyether polyols and polyester polyols not described above. Chain extenders and/or crosslinking agents include, for example, ethylene glycol, propylene glycol, butylene glycol, glycerol, diethylene glycol, dipropylene glycol, dibutylene glycol, trimethylolpropane, pentaerythritol, ethylene diamine, and diethyltoluenediamine. Polyester polyols may be prepared from, for example, an organic dicarboxylic acid having 2 to 12 carbon atoms, such as an aliphatic dicarboxylic acid having 4 to 6 carbon atoms, and a polyvalent alcohol, such as a diol or triol having 2 to 12 carbon atoms. Examples of the dicarboxylic acid are succinic acid, glutaric acid, adipic acid, suberic acid, azelaic acid, sebacic acid, decanedicarboxylic acid, maleic acid, fumaric acid, phthalic acid, isophthalic acid and terephthalic acid. Instead of a free dicarboxylic acid, a corresponding dicarboxylic acid derivative such as a dicarboxylic acid monoester or diester prepared by esterification with an alcohol having 1 to 4 carbon atoms or dicarboxylic anhydride can be used.

In some embodiments, however, the isocyanate-reactive composition is substantially free, or completely free, of one or more of (i) aromatic amine-initiated polyether polyol, (ii) polyester polyol, (iii) aliphatic polyamine-initiated polyether polyols, (iv) polyoxyalkylene glycol; and (v) polymer polyol. As used herein, the term “substantially free” when used with reference to the absence of a polyol in the polyol blend, means that such polyol is present in the polyol blend, if present at all, in an amount less than 1% by weight, based on the total weight of the polyol blend. Further, in some implementations, the sum of the amount of the previously described alkanolamine-initiated polyether polyol, saccharide-initiated polyether polyol, and aliphatic triol-initiated polyether polyol in the polyol blend is 90 to 100% by weight, such as 95 to 100% by weight, 99 to 100% by weight, or 99.9 to 100% by weight, based on the total weight of the polyol blend.

In certain embodiments, the polyol blend has a weighted average functionality of 3 to 6, 3 to 5, or 3 to 4, and/or a weighted average hydroxyl number of 300 to 600 mg KOH/g polyol, such as 400 to 500 mg KOH/g polyol, or 450 to 500 mg KOH/g polyol, and/or a weighted average molecular weight of 200 to 800 g/mol, such as 200 to 600 g/mol or 400 to 500 g/mol.

In the isocyanate-reactive compositions of this specification, the polyol blend has a content of —C₂H₄O— units of 2 to 15% by weight, based on the total weight of the isocyanate-reactive composition. For example, in some implementations, the polyol blend has a content of —C₂H₄O— units of 3 to 14% by weight, 4 to 13% by weight, 5 to 12% by weight, 6 to 11% by weight, 7 to 10% by weight, 7 to 9% by weight, or 7 to 8% by weight, based on the total weight of the isocyanate-reactive composition. It has been observed that by including such a content of —C₂H₄O— units in the polyol blend it was possible to produce foams exhibiting improved thermal insulation properties to comparable foams having the same HCFO content or to produce foams having similar thermal insulation properties to comparable foams having a higher HCFO content (and also a higher gel catalyst content).

The isocyanate-reactive composition of this specification comprise a blowing agent composition. The blowing agent composition comprises: (1) a physical blowing agent comprising a HCFO; and (2) a carbon dioxide generating chemical blowing agent.

Suitable HCFOs include, for example, 1-chloro-3,3,3-trifluoropropene (HCFO-1233zd, E and/or Z isomers), 2-chloro-3,3,3-trifluoropropene (HCFO-1233xf), HCF01223, 1,2-dichloro-1,2-difluoroethene (E and/or Z isomers), 3,3-dichloro-3-fluoropropene, 2-chloro-1,1,1,4,4,4-hexafluorobutene-2 (E and/or Z isomers), and 2-chloro-1,1,1,3,4,4,4-heptafluorobutene-2 (E and/or Z isomers), as well as mixtures of any two or more thereof. In some implementations, the boiling point, at atmospheric pressure, of the HCFO is at least −25° C., at least −20° C., or, in some cases, at least −19° C., and 40° C. or less, such as 35° C. or less, or, in some cases 33° C. or less. The HCFO may have a boiling point, at atmospheric pressure, of, for example, −25° C. to 40° C., or −20° C. to 35° C., or −19° C. to 33° C.

In some implementations, the HCFO is present in an amount of at least 1% by weight, such as 5 to 30% by weight, such as 5 to 20% by weight, 5 to 15% by weight or 10 to 15% by weight, based on the total weight of the polyol blend. In other implementations, however, HCFO is present in an amount of 4 to less than 12% by weight, 8 to less than 12% by weight, or 9 to 11% by weight, based on the total weight of the polyol blend.

In certain implementations, the isocyanate-reactive composition comprises one or more other physical blowing agents, such as other halogenated blowing agents, such as CFCs, HCFCs, and/or HFCs and/or hydrocarbon blowing agents, such as butane, n-pentane, cyclopentane, hexane, and/or isopentane (i.e. 2-methylbutane). In other embodiments, the isocyanate-reactive composition is substantially or, in some cases, completely free, of other physical blowing agents, such as other halogenated blowing agents, such as CFCs, HCFCs, and/or HFCs and/or hydrocarbon blowing agents, such as butane, n-pentane, cyclopentane, hexane, and/or isopentane (i.e. 2-methylbutane). As used herein, the term “substantially free” when used with reference to these blowing agents, means that the blowing agent is present, if at all, in an amount of less than 10% by weight, such as less than 1% by weight, based on the total weight of the blowing agent composition.

As indicated above, the isocyanate-reactive composition comprises a carbon dioxide generating chemical blowing agent, such as water and/or a formate-blocked amine.

In some of these implementations, the chemical blowing agent, such as water, is utilized in an amount of 0.5 to 10.0% by weight, 2 to 8% by weight, 3.0 to 7.0% by weight, or 4.0 to 6.0% by weight, based on the total weight of the polyol blend.

In certain implementations, the blowing agent composition comprises HCFO and a carbon dioxide generating chemical blowing agent, such as water, wherein the HCFO and the carbon dioxide generating chemical blowing agent are present in an amount of at least 90% by weight, such as at least 95% by weight, or, in some cases, at least 99% by weight, based on the total weight of the blowing agent composition. In certain implementations, the HCFO and a carbon dioxide generating chemical blowing agent are present in the blowing agent composition at a weight ratio of at least 2:1, such as 2:1 to 10:1, 2:1 to 4:1, 2:1 to 3:1, or 2.0:1 to 2.5:1.

In some implementations, the isocyanate-reactive composition also comprises a surfactant. Any suitable surfactant can be used including organosilicon compounds, such as polysiloxane-polyalkyene-block copolymers, such as a polyether-modified polysiloxane. Other useful surfactants include polyethylene glycol ethers of long chain alcohols, tertiary amine or alkanolamine salts of long chain alkyl acid sulfate esters, alkylsulfonic esters, or alkylarylsulfonic acids. Such surfactants are employed in amounts sufficient to stabilize the foaming reaction mixture against collapse and the formation of large and uneven cells. In some embodiments, surfactant is utilized in an amount of 0.2 to 5.0% by weight, such as 1 to 3% by weight, based on the total weight of the polyol blend.

As previously indicated, the isocyanate-reactive composition further comprises a catalyst composition comprising a tertiary amine. In some implementations, the tertiary amine comprises a gel catalyst comprising an arylalkyl tertiary amine, an aryl tertiary amine, or a mixture thereof. As will be appreciated, a “gel catalyst” refers to a catalyst that has a greater effect on the urethane-forming reaction of a polyol and polyisocyanate than it does on the water-polyisocyanate blowing reaction. Suitable arylalkyl tertiary amines include N,N-dialkylbenzylamines, such as those where each alkyl group of the N,N-dialkylbenzylamine independently contains 1 to 6 carbon atoms, such as where each alkyl group is independently methyl, ethyl, or propyl. In particular, in some implementations, the N,N,-dialkylbenzylamine comprises N, N-dimethylbenzylamine (CAS No. 103-83-3), N,N-diethylbenzylamine, or a combination thereof. Another suitable arylalkyl tertiary amine is dibenzylethylamine. Suitable aryl tertiary amines included, for example, N,N-dimethylaniline, N,N-diethylaniline, N-methyl-N-ethylaniline, N,N-diisopropylaniline, or a mixture of any two or more thereof.

In some implementations, the arylalkyl tertiary amine, an aryl tertiary amine, or a mixture thereof is present in an amount of 0.1 to 5% by weight, 0.1 to 3% by weight, 0.1 to 2% by weight, 0.1 to 1.5% by weight, or, in some cases, 0.1 to less than 1.0% by weight, such as 0.2 to 0.9%, 0.4 to 0.8% by weight, or 0.6 to 0.7% by weight, based on the total weight of the polyol blend. In fact, it was observed that a further advantage of the present invention that arises due to the ability to use significantly reduced amounts of HCFO is that a reduced amount of such gel catalyst can therefore be used to maintain a desirable high blow to gel reaction ratio.

In some implementations, tertiary amine catalyst composition further comprises a “blow catalyst” that has a greater effect on the water-polyisocyanate blowing reaction than it does on the polyol-polyisocyanate urethane-forming reaction. More specifically, however, in some implementations such “blow catalyst” is selected such that its presence does not detrimentally effect the shelf-life stability of the isocyanate-reactive composition. As a result, in some implementations, the blow catalyst comprises a morpholine. Suitable morpholine catalysts include, for example, dimorpholinodiethylether, dimorpholinodimethylether, N-ethylmorpholine, and N-methylmorpholine.

In some implementations, the catalyst composition comprises: (1) a gel catalyst; and (2) a blow catalyst, in which (i) the gel catalyst comprises an arylalkyl tertiary amine, an aryl tertiary amine, or a mixture thereof that is present in an amount of 0.1 to 5% by weight, 0.1 to 3% by weight, 0.1 to 2% by weight, 0.1 to 0.9% by weight, 0.4 to 0.8% by weight, or 0.5 to 0.7% by weight, based on the total weight of the polyol blend; and (ii) the blow catalyst and gel catalyst are present in a relative ratio, by weight, of at least 1:1, such as 1:1 to 10:1, 1:1 to 3:1, 4:1 to 8:1, or 5:1 to 7:1. Moreover, in some implementations, the catalyst composition comprises: (i) 50 to 90% by weight, such as 60 to 80% by weight, or, in some cases, 85 to 90% by weight, based on the total weight of the catalyst composition, of a blow catalyst, such as a morpholine; and (ii) 10 to 50% by weight, such as 20 to 40% by weight, or, in some cases, 10 to 15%% by weight, based on the total weight of the catalyst composition, of a arylalkyl tertiary amine, an aryl tertiary amine, or a mixture thereof.

In certain embodiments, the catalyst composition does not include an acid-blocked amine catalyst. In certain embodiments, the isocyanate-reactive composition does not include a metal catalyst and/or any other catalyst that is not a tertiary amine catalyst.

In certain embodiments, the total amount of catalyst composition present is 1 to 10% by weight, 4.0 to 8.0% or 5.0 to 7.0% by weight, based on the total weight of the polyol blend.

Additional materials which may optionally be included in the foam-forming compositions of the present invention include: pigments, colorants, fillers, antioxidants, flame retardants, and stabilizers. Exemplary flame retardants useful in the foam-forming composition of the present invention include, but are not limited to, reactive bromine based compounds and chlorinated phosphate esters, including but not limited to, tri(2-chloroethyl)phosphate (TECP), tri(1,3-dichloro-2-propyl)phosphate, tri(1-chloro-2-propyl)phosphate (TCPP) and dimethyl propyl phosphate (DMPP).

As will be appreciated, other embodiments of this specification are directed to rigid polyurethane-foam forming compositions that comprise: (a) a diisocyanate and/or polyisocyanate (collectively “polyisocyanate”); and (b) an isocyanate-reactive composition of the type described above.

Any of the known organic polyisocyanates, modified polyisocyanates or isocyanate-terminated prepolymers made from any of the known organic isocyanates may be used. Suitable organic isocyanates include aromatic, aliphatic, and cycloaliphatic polyisocyanates and combinations thereof. Useful polyisocyanates include: diisocyanates, such as m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,3-cyclohexane diisocyanate, 1,4-cyclo-hexane diisocyanate, isomers of hexahydro-toluene diisocyanate, isophorone diisocyanate, dicyclo-hexylmethane diisocyanates, 1,5-naphthylene diisocyanate, 4,4′-diphenylmethane diisocyanate, 2,4′-diphenylmethane diisocyanate, 4,4′-biphenylene diisocyanate, 3,3′-dimethoxy-4,4′-biphenylene diisocyanate and 3,3′-dimethyl-diphenyl-propane-4,4′-diisocyanate; triisocyanates such as 2,4,6-toluene triisocyanate; and polyisocyanates such as 4,4′-dimethyl-diphenylmethane-2,2′,5,5′-tetraisocyanate and the polymethylene polyphenyl-polyisocyanates.

Undistilled or crude polyisocyanates may also be used. The crude toluene diisocyanate obtained by phosgenating a mixture of toluene diamines and the crude diphenylmethane diisocyanate obtained by phosgenating crude diphenylmethanediamine (polymeric MDI) are examples of suitable crude polyisocyanates. Suitable undistilled or crude polyisocyanates are disclosed in U.S. Pat. No. 3,215,652.

Modified polyisocyanates are obtained by chemical reaction of polyisocyanates. Useful modified polyisocyanates include, but are not limited to, those containing ester groups, urea groups, biuret groups, allophanate groups, carbodiimide groups, isocyanurate groups, uretdione groups and/or urethane groups. Examples of modified polyisocyanates include prepolymers containing NCO groups and having an NCO content of from 25 to 35 weight percent, such as from 29 to 34 weight percent, such as those based on polyether polyols or polyester polyols and diphenylmethane diisocyanate.

In certain embodiments, the polyisocyanate comprises a methylene-bridged polyphenyl polyisocyanate and/or a prepolymer of methylene-bridged polyphenyl polyisocyanates having an average functionality of 1.8 to 3.5, such as 2.0 to 3.1, isocyanate moieties per molecule and an NCO content of 25 to 32 weight percent.

The present specification is also directed to processes for producing rigid polyurethane foams. In such processes, an organic polyisocyanate is reacted with an isocyanate-reactive composition of the type described above. In some embodiments, the isocyanate functional component and the isocyanate-reactive composition are mixed at an isocyanate index of from 0.90 to 1.80, 0.90 to 1.50, 0.90 to 1.40, or 1.00 to 1.20. Further, in some implementations, the resulting mixture has a content of —C₂H₄O— units of 1 to 5% by weight, based on the total weight of the reaction mixture, i.e., the polyurethane foam-forming composition. For example, in some implementations, the polyurethane foam-forming composition has a content of —C₂H₄O— units of 1 to 4% by weight, 1 to 3% by weight, 1.5 to 3% by weight, or 1.5 to 2.5% by weight, based on the total weight of the reaction mixture, i.e., the polyurethane foam-forming composition.

In certain embodiments, the polyol blend of the isocyanate-reactive composition is reacted with an organic polyisocyanate in the presence of a blowing agent, water, a tertiary amine catalyst composition, a surfactant and any other optional ingredients. The rigid foams may be prepared by blending all of the components of the isocyanate-reactive composition together in a phase stable mixture, and then mixing this in the proper ratio with the organic polyisocyanate. Alternatively, one or more of the components, such as the surfactant, may be combined with the organic polyisocyanate prior to mixing it with the isocyanate-reactive composition. Other possibilities include adding one or more of the components as a separate stream, together with the polyol blend and the organic polyisocyanate.

Many foam machines are designed to condition and mix only two components in the proper ratio. For use of such machines, a premix of all the components except the polyisocyanate can be advantageously employed. According to the two-component method (component A: polyisocyanate; and component B: isocyanate-reactive composition which typically includes the polyol blend, blowing agent, water, catalyst and surfactant), the components may be mixed in the proper ratio at a temperature of 5 to 50° C., such as 15 to 35° C., injected or poured into a mold having the temperature controlled to within a range of 20 to 70° C., such as 35 to 60° C. The mixture then expands to fill the cavity with the rigid polyurethane foam.

Furthermore, the rigid polyurethane foam can be prepared in a batch or continuous process by the one-shot or quasi-prepolymer methods using any well-known foaming apparatus.

For closed-cell insulating foams, the object is to retain the blowing agent in the cells to maintain a low thermal conductivity of the insulating material, i.e., the rigid polyurethane foam. Thus, a high closed-cell content in the foam is desirable. Foams produced according to embodiments of the present specification have more than 80 percent, typically more than 85 percent, or more than 88 percent closed-cell content as measured according to ASTM D6226-15. Furthermore, the thermal conductivity of foams produced according to various embodiments of the present specification, measured at 35° F. (2° C.), is less than 0.160 BTU-in/h-ft²-° F. for foam from the core of 2-inch thick panels, as measured according to ASTM C518-17.

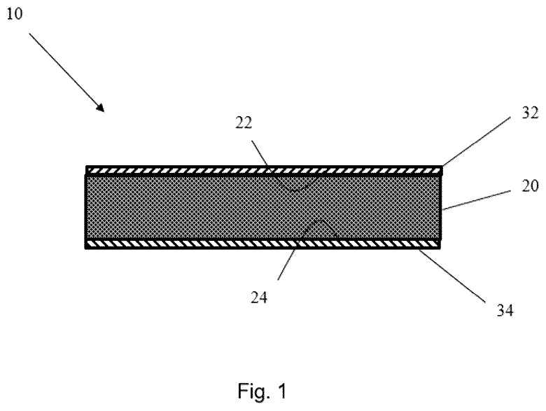

This specification also relates to the use of the rigid polyurethane foams described herein for thermal insulation. More particularly the rigid foams can be used, for example, as an intermediate layer between substrates to form a composite article. Thus, referring now to FIG. 1, this specification is also directed to a composite articles 10 that comprise a rigid polyurethane foam core 20 as disclosed herein. The rigid polyurethane foam core includes a face 22 that is adhered to substrate 32 and a face 24 that is adhered to substrate 34. As a result, the polyurethane foam core 20 is sandwiched between substrates 32 and 34.

In certain embodiments, the substrate may be plastic (such a polypropylene resin reinforced with continuous bi-directional glass fibers or a fiberglass reinforced polyester copolymer), paper, wood, or metal, such as steel or aluminum. In some implementations, for example, the substrate may comprise a relatively thin sheet of metal, such as steel, such as those having a thickness of 0.021 inch to 0.027 inch (0.53 millimeter to 0.69 millimeter).

It is currently believed that the particular isocyanate-reactive compositions described herein are capable of producing rigid foams that have a particular combination of properties that can make them suitable for use in sandwich composites for entry doors.

Various aspects of the subject matter described herein are set out in the following numbered clauses:

Clause 1. An isocyanate-reactive composition comprising: (a) a polyol blend comprising 1 to 20% by weight, based on the total weight of the polyol blend, of an alkanolamine-initiated polyether polyol having an OH number of at least 500 mg KOH/g polyol and a functionality of 2.5 to 4, wherein the polyol blend has a content of —C₂H₄O— units of 2 to 15% by weight, based on the total weight of the isocyanate-reactive composition; (b) a blowing agent composition comprising: (1) a physical blowing agent; and (2) a carbon dioxide-generating chemical blowing agent; and (c) a catalyst composition comprising a tertiary amine, wherein (i) the chemical blowing agent is present in an amount of 3 to 6% by weight, based on the total weight of the polyol blend, (ii) the physical blowing agent comprises a hydrochlorofluoroolefin that is present in an amount of 4 to less than 12% by weight, based on total weight of the polyol blend, and in an amount of at least 80% by weight, based on total weight of the physical blowing agent present in the blowing agent composition, and (iii) the physical blowing agent and the chemical blowing agent are present in a relative ratio, by weight, of 1:1 to 3:1.

Clause 2. The isocyanate-reactive composition of clause 1, wherein alkanolamine is present in an amount of at least 80% by weight, at least 90% by weight, at least 95% by weight, or 100% by weight, based on the total weight of H-functional initiator oxide used to prepare the alkanolamine-initiated polyether polyol.

Clause 3. The isocyanate-reactive composition of clause 1 or clause 2, wherein the alkanolamine is represented by the formula NH₂—Z—OH, in which Z represents a divalent radical which is a straight chain or branched chain alkylene radical having 2 to 6 carbon atoms, a cycloalkylene radical having 4 to 6 carbon atoms or a dialkylene ether radical having 4 to 6 carbon atoms, such as where the dialkylene ether radical is be represented by the formula —R—O—R— in which each R represents a hydrocarbon radical having 2 to 3 carbon atoms.

Clause 4. The isocyanate-reactive composition of one of clause 1 to clause 3, wherein the alkanolamine used to prepare the alkanolamine-initiated polyether polyol comprises monoethanolamine, 1-amino-2-propanol, 2-amino-1-propanol, 3-amino-1-propanol, 1-(2-aminoethoxy) ethanol, 1-amino-2-butanol, 2-amino-3-butanol, 2-amino-2-methylpropanol, 5-amino pentanol, 3-amino-2, 2-dimethyl propanol, 4-aminocyclohexanol, or a mixture of any two or more thereof.

Clause 5. The isocyanate-reactive composition of one of clause 1 to clause 4, wherein the alkylene oxide used to prepare the alkanolamine-initiated polyether polyol comprises propylene oxide in an amount of at least 80% by weight, at least 90% by weight, at least 95% by weight, or 100% by weight, based on the total weight of alkylene oxide used to prepare the alkanolamine-initiated polyether polyol.

Clause 6. The isocyanate-reactive composition of one of clause 1 to clause 5, wherein the alkanolamine-initiated polyether polyol has an OH number of 500 to 900 mg KOH/g polyol, 600 to 800 mg KOH/g polyol, or 680 to 720 mg KOH/g polyol, and/or a functionality of 2.5 to 3.5.

Clause 7. The isocyanate-reactive composition of one of clause 1 to clause 6, wherein the alkanolamine-initiated polyether polyol is present in an amount of 5 to 20% by weight, 10 to 20% by weight, or 10 to 15% by weight, based upon the total weight of the polyol blend.

Clause 8. The isocyanate-reactive composition of one of clause 1 to clause 7, wherein the polyol blend further comprises a saccharide-initiated polyether polyol that is different from the previously described alkanolamine-initiated polyether polyol.

Clause 9. The isocyanate-reactive composition of clause 8, wherein saccharide is present in an amount of at least 50% by weight or 50 to 90% by weight, based on the total weight of H-functional initiator used to prepare the saccharide-initiated polyether polyol.

Clause 10. The isocyanate-reactive composition of clause 8 or clause 9, wherein the saccharide comprises sucrose, sorbitol, maltitol, or a mixture of any two or more thereof, such as water, propylene glycol, glycerin, ethylene glycol, an ethanol amine, diethylene glycol, or a mixture of any two or more thereof, is present as a co-initiator with the saccharide to produce the saccharide-initiated polyether polyol.

Clause 11. The isocyanate-reactive composition of one of clause 8 to clause 10, wherein the alkylene oxide used to produce the saccharide-initiated polyether polyol comprises ethylene oxide, propylene oxide, butylene oxide, styrene oxide, epichlorohydrin, or a mixture of any two or more thereof, such as where (1) the alkylene oxide comprises propylene oxide in an amount of greater than 80% by weight, at least 90% by weight, or at least 95% by weight, based on the total weight of alkylene oxide used to prepare the saccharide-initiated polyether polyol, or (2) where the alkylene oxide comprises propylene oxide in an amount of 50 to 80% by weight, such as 60 to 80% by weight or 65 to 75% by weight, based on the total weight of alkylene oxide used to prepare the saccharide-initiated polyether polyol, and ethylene oxide in used in an amount of 10 to 50% by weight, such as 20 to 40% by weight, or 25 to 35% by weight, based on the total weight of alkylene oxide used to prepare the saccharide-initiated polyether polyol.

Clause 12. The isocyanate-reactive composition of one of clause 8 to clause 11, wherein the saccharide-initiated polyether polyol comprises: (i) a first saccharide-initiated polyether polyol in which propylene oxide is used in an amount of greater than 80% by weight, at least 90% by weight, or, in some cases, at least 95% by weight, or 100% by weight, based on the total weight of alkylene oxide used to prepare the first saccharide-initiated polyether polyol, and (ii) a second saccharide-initiated polyether polyol in which propylene oxide is used in an amount of 50 to 80% by weight, 60 to 80% by weight, or 65 to 75% by weight, based on the total weight of alkylene oxide used to prepare the second saccharide-initiated polyether polyol, and ethylene oxide in used in an amount of 10 to 50% by weight, 20 to 40% by weight, or 25 to 35% by weight, based on the total weight of alkylene oxide used to prepare the second saccharide-initiated polyether polyol.

Clause 13. The isocyanate-reactive composition of one of clause 8 to clause 12, wherein the saccharide-initiated polyether polyol has an OH number of 200 to 600 mg KOH/g polyol, 300 to 550 mg KOH/g polyol, or 400 to 500 mg KOH/g polyol, and a functionality of 4 to 6, such as where the saccharide-initiated polyether polyol comprises: (i) the first saccharide-initiated polyether polyol described in clause 12 that has an OH number of 200 to 600 mg KOH/g polyol, 300 to 500 mg KOH/g polyol, or 400 to 450 mg KOH/g polyol, and a functionality of 4 to 6, 4 to 5, or 4.0 to 4.5, and (ii) the second saccharide-initiated polyether polyol described in clause 12 that has an OH number of 200 to 600 mg KOH/g polyol, 300 to 500 mg KOH/g polyol, or greater than 450 to 500 mg KOH/g polyol, and a functionality of 4 to 6, 5 to 6, or 5.2 to 5.8.

Clause 14. The isocyanate-reactive composition of one of clause 8 to clause 13, wherein the saccharide-initiated polyether polyol is present in an amount of 50 to 90% by weight, 60 to 80% by weight, or 65 to 75% by weight, based on the total weight of the polyol blend, such as where the saccharide-initiated polyether polyol comprises: (i) the first saccharide-initiated polyether polyol described in clause 12 that is present in an amount of 10 to 40% by weight or 20 to 30% by weight, based on total weight of the polyol blend, and (ii) the second saccharide-initiated polyether polyol described in clause 12 that is present in amount of 30 to 80% by weight, 30 to 60% by weight, 30 to 50% by weight, or 40 to 50% by weight, based on total weight of the polyol blend.

Clause 15. The isocyanate-reactive composition of one of clause 12 to clause 14, wherein the second saccharide-initiated polyether polyol and the first saccharide-initiated polyether polyol are present in a relative ratio, by weight, of 1:1 to 3:1, 1:1 to 2:1, or 1.5:1 to 2:1.

Clause 16. The isocyanate-reactive composition of one of clause 8 to clause 15, wherein the saccharide-initiated polyether polyol and the alkanolamine-initiated polyether polyol are present in the polyol blend at a weight ratio of at least 1:1, 1:1 to 10:1, or 2:1 to 8:1; 4:1 to 8:1 or 5:1 to 6:1.

Clause 17. The isocyanate-reactive composition of one of clause 1 to clause 16, wherein the polyol blend further comprises an aliphatic triol-initiated polyether polyol that is different from the alkanolamine-initiated polyether polyol and the saccharide-initiated polyether polyol.

Clause 18. The isocyanate-reactive composition of clause 17, wherein aliphatic triol is present in an amount of 50% to 100% by weight, 80 to 100% by weight, 90 to 100% by weight, or 100% by weight, based on the total weight of H-functional initiator used to prepare the aliphatic triol-initiated polyether polyol.

Clause 19. The isocyanate-reactive composition of clause 17 or clause 18, wherein the aliphatic triol comprises glycerin, wherein the glycerin is optionally used in combination a saccharide, water, propylene glycol, ethylene glycol, an ethanol amine, diethylene glycol, or a mixture of any two or more thereof.

Clause 20. The isocyanate-reactive composition of one of clause 17 to clause 19, wherein propylene oxide is present in an amount of greater than 80% by weight, at least 90% by weight, at least 95% by weight, or 100% by weight, based on the total weight of alkylene oxide used to prepare the aliphatic triol-initiated polyether polyol.

Clause 21. The isocyanate-reactive composition of one of clause 17 to clause 20, wherein the aliphatic triol-initiated polyether polyol has a hydroxyl number of 200 to 800 mg KOH/g polyol, 300 to 600 mg KOH/g polyol, 400 to 500 mg KOH/g polyol, or 450 to 500 mg KOH/g polyol, and/or a functionality of greater than 2 to less than 4, 2.5 to 3.5, or 3.0.

Clause 22. The isocyanate-reactive composition of one of clause 17 to clause 21, wherein the aliphatic triol-initiated polyether polyol is present in an amount of 10 to 50% by weight, 10 to 40% by weight, 10 to 30% by weight, or 15 to 25% by weight, based on the total weight of the polyol blend.

Clause 23. The isocyanate-reactive composition of one of clause 17 to clause 22, wherein the polyol blend comprises both the saccharide-initiated polyether polyol and the aliphatic triol-initiated polyether polyol, in which the saccharide-initiated polyether polyol and aliphatic triol-initiated polyether polyol are present in the polyol blend in a weight ratio of 1:10 to 10:1, 1:1 to 10:1, 1:1 to 5:1, or 2:1 to 4:1.

Clause 24. The isocyanate-reactive composition of one of clause 17 to clause 23, wherein the aliphatic triol-initiated polyether polyol and alkanolamine-initiated polyether polyol are present in the polyol blend at a weight ratio of at least 1:1, 1:1 to 10:1, or 1:1 to 5:1; 1:1 to 2:1 or 1.2:1 to 1.8.1.

Clause 25. The isocyanate-reactive composition of one of clause 1 to clause 24, wherein the isocyanate-reactive composition is substantially free, or completely free, of one or more of (i) aromatic amine-initiated polyether polyol, (ii) polyester polyol, (iii) aliphatic polyamine-initiated polyether polyols, (iv) polyoxyalkylene glycol; and (v) polymer polyol.

Clause 26. The isocyanate-reactive composition of one of clause 1 to clause 25, wherein the sum of the amount of the alkanolamine-initiated polyether polyol, saccharide-initiated polyether polyol, and aliphatic triol-initiated polyether polyol in the polyol blend is 90 to 100% by weight, 95 to 100% by weight, 99 to 100% by weight, or 99.9 to 100% by weight, based on the total weight of the polyol blend.

Clause 27. The isocyanate-reactive composition of one of clause 1 to clause 26, wherein the polyol blend has a weighted average functionality of 3 to 6, 3 to 5 or 3 to 4, and/or a weighted average hydroxyl number of 300 to 600 mg KOH/g polyol, 400 to 500 mg KOH/g polyol, or 450 to 500 mg KOH/g polyol, and/or a weighted average molecular weight of 200 to 800 g/mol, 200 to 600 g/mol or 400 to 500 g/mol.

Clause 28. The isocyanate-reactive composition of one of clause 1 to clause 27, wherein the polyol blend has a content of —C₂H₄O— units of 3 to 14% by weight, 4 to 13% by weight, 5 to 12% by weight, 6 to 11% by weight, 7 to 10% by weight, 7 to 9% by weight, or 7 to 8% by weight, based on the total weight of the isocyanate-reactive composition.

Clause 29. The isocyanate-reactive composition of one of clause 1 to clause 28, wherein the HCFO comprises 1-chloro-3,3,3-trifluoropropene (HCFO-1233zd, E and/or Z isomers), 2-chloro-3,3,3-trifluoropropene (HCFO-1233xf), HCFO1223, 1,2-dichloro-1,2-difluoroethene (E and/or Z isomers), 3,3-dichloro-3-fluoropropene, 2-chloro-1,1,1,4,4,4-hexafluorobutene-2 (E and/or Z isomers), and 2-chloro-1,1,1,3,4,4,4-heptafluorobutene-2 (E and/or Z isomers), or a mixture of any two or more thereof.

Clause 30. The isocyanate-reactive composition of one of clause 1 to clause 29, wherein the HCFO is present in an amount of 8 to less than 12% by weight or 9 to 11% by weight, based on the total weight of the polyol blend.

Clause 31. The isocyanate-reactive composition of one of clause 1 to clause 30, wherein the isocyanate-reactive composition is substantially or completely free of other physical blowing agents, such as other halogenated blowing agents, such as CFCs, HCFCs, and/or HFCs and/or hydrocarbon blowing agents.

Clause 32. The isocyanate-reactive composition of one of clause 1 to clause 31, wherein the chemical blowing agent, such as water, is present in an amount of 0.5 to 10.0% by weight, 2 to 8% by weight, 3.0 to 7.0% by weight, or 4.0 to 6.0% by weight, based on the total weight of the polyol blend.

Clause 33. The isocyanate-reactive composition of one of clause 1 to clause 32, wherein the HCFO and the carbon dioxide generating chemical blowing agent are present in an amount of at least 90% by weight, at least 95% by weight, at least 99% by weight, or 100% by weight, based on the total weight of the blowing agent composition.

Clause 34. The isocyanate-reactive composition of one of clause 1 to clause 33, wherein the HCFO and a carbon dioxide generating chemical blowing agent are present in the blowing agent composition at a weight ratio of at least 2:1, such as 2:1 to 10:1, 2:1 to 4:1, 2:1 to 3:1, or 2.0:1 to 2.5:1.

Clause 35. The isocyanate-reactive composition of one of clause 1 to clause 34, wherein the tertiary amine comprises an arylalkyl tertiary amine, an aryl tertiary amine, or a mixture thereof.

Clause 36. The isocyanate-reactive composition of clause 35, wherein the tertiary amine comprises a N,N-dialkylbenzylamine, such as those where each alkyl group of the N,N-dialkylbenzylamine independently contains 1 to 6 carbon atoms, such as N, N-dimethylbenzylamine (CAS No. 103-83-3) or N,N-diethylbenzylamine; dibenzylethylamine; N,N-dimethylaniline; N,N-diethylaniline; N-methyl-N-ethylaniline; N,N-diisopropylaniline; or a mixture of any two or more thereof.

Clause 37. The isocyanate-reactive composition of clause 35 or clause 36, wherein the arylalkyl tertiary amine, an aryl tertiary amine, or a mixture thereof is present in an amount of 0.1 to 5% by weight, 0.1 to 3% by weight, 0.1 to 2% by weight, 0.1 to 1.5% by weight, 0.1 to less than 1.0% by weight, 0.2 to 0.9%, 0.4 to 0.8% by weight, or 0.6 to 0.7% by weight, based on the total weight of the polyol blend.

Clause 38. The isocyanate-reactive composition of one of clause 1 to clause 37, wherein the catalyst composition further comprises a blow catalyst comprising a morpholine, such as dimorpholinodiethylether, dimorpholinodimethylether, N-ethylmorpholine, N-methylmorpholine, or a mixture of any two or more thereof.

Clause 39. The isocyanate-reactive composition of one of clause 1 to clause 38, wherein the catalyst composition comprises: (1) a gel catalyst; and (2) a blow catalyst, in which (i) the gel catalyst comprises an arylalkyl tertiary amine, an aryl tertiary amine, or a mixture thereof that is present in an amount of 0.1 to 5% by weight, 0.1 to 3% by weight, 0.1 to 2% by weight, 0.1 to less than 1% by weight, 0.1 to 0.9% by weight, 0.4 to 0.8% by weight, or 0.6 to 0.7% by weight, based on the total weight of the polyol blend; and (ii) the blow catalyst and gel catalyst are present in a relative ratio, by weight, of at least 1:1, 1:1 to 10:1, 1:1 to 3:1, 2:1 to 8:1, or 3:1 to 6:1.

Clause 40. The isocyanate-reactive composition of one of clause 1 to clause 39, wherein the catalyst composition comprises: (i) 50 to 90% by weight, such as 60 to 80% by weight, or, in some cases, 85 to 90% by weight, based on the total weight of the catalyst composition, of a blow catalyst, such as a morpholine; and (ii) 10 to 50% by weight, such as 20 to 40% by weight, or, in some cases, 10 to 15%% by weight, based on the total weight of the catalyst composition, of a arylalkyl tertiary amine, an aryl tertiary amine, or a mixture thereof.

Clause 41. The isocyanate-reactive composition of one of clause 1 to clause 40, wherein the catalyst composition does not include an acid-blocked amine catalyst.

Clause 42. The isocyanate-reactive composition of one of clause 1 to clause 41, wherein the isocyanate-reactive composition does not include a metal catalyst and/or any other catalyst that is not a tertiary amine catalyst.

Clause 43. The isocyanate-reactive composition of one of clause 1 to clause 42, wherein the catalyst composition is present in an amount of 1 to 10% by weight, 4.0 to 8.0% or 5.0 to 7.0% by weight, based on the total weight of the polyol blend.

Clause 44. A polyurethane foam-forming compositions comprising: (a) a polyisocyanate; and (b) the isocyanate-reactive composition of one of clause 1 to clause 43, such as where the polyurethane foam-forming composition has an isocyanate index of 0.90 to 1.80, 0.90 to 1.50, 0.90 to 1.40, or 1.00 to 1.20.

Clause 45. The polyurethane foam-forming composition of clause 44, wherein the polyurethane foam-forming composition has a content of —C₂H₄O— units of 1 to 5% by weight, 1 to 4% by weight, 1 to 3% by weight, 1.5 to 3% by weight, or 1.5 to 2.5% by weight, based on the total weight of the polyurethane foam-forming composition.

Clause 46. The polyurethane foam-forming composition of clause 44 or clause 45, wherein the polyisocyanate comprises a methylene-bridged polyphenyl polyisocyanate and/or a prepolymer of methylene-bridged polyphenyl polyisocyanates having an average functionality of 1.8 to 3.5 or 2.0 to 3.1 isocyanate moieties per molecule and an NCO content of 25 to 32 weight percent.

Clause 47. A polyurethane foam formed from the polyurethane foam-forming composition of one of clause 44 to clause 46.

Clause 48. The polyurethane foam of clause 47, wherein the polyurethane foam has more than 80 percent, more than 85 percent, or more than 88 percent closed-cell content as measured according to ASTM D6226-15 and/or wherein the polyurethane foam has a thermal conductivity, measured at 35° F. (2° C.), of less than 0.160 BTU-in/h-ft2-° F. for foam from the core of 2-inch thick panels, as measured according to ASTM C518-17.

Clause 49. A composite article comprising a polyurethane foam core comprising the polyurethane foam of one of clause 44 to clause 48, wherein the polyurethane foam core includes a first face that is adhered to a first substrate and a second face that is adhered to a second substrate, such as where the composite article comprises an entry door.

Clause 50. The composite article of clause 49, wherein the first substrate and/or the second substrate is made of plastic (such a polypropylene resin reinforced with continuous bi-directional glass fibers or a fiberglass reinforced polyester copolymer), paper, wood, or metal, such as steel or aluminum, such as where the first substrate and the second substrate comprise a sheet of metal, such as steel, having a thickness of 0.021 inch to 0.027 inch (0.53 millimeter to 0.69 millimeter).

Clause 51. An isocyanate-reactive composition comprising: (a) a polyol blend comprising 1 to 20% by weight, based on the total weight of the polyol blend, of an alkanolamine-initiated polyether polyol having an OH number of at least 500 mg KOH/g polyol and a functionality of 2.5 to 4, wherein the polyol blend has a content of —C₂H₄O— units of 2 to 15% by weight, based on the total weight of the isocyanate-reactive composition; (b) a blowing agent composition comprising (1) a HCFO; and (2) a carbon dioxide-generating chemical blowing agent; and (c) a catalyst composition comprising an arylalkyl tertiary amine, an aryl tertiary amine, or a mixture thereof that is present in an amount of 0.1 to less than 1.0% by weight, based on the total weight of the polyol blend.

Clause 52. The isocyanate-reactive composition of clause 51, wherein alkanolamine is present in an amount of at least 80% by weight, at least 90% by weight, at least 95% by weight, or 100% by weight, based on the total weight of H-functional initiator oxide used to prepare the alkanolamine-initiated polyether polyol.

Clause 53. The isocyanate-reactive composition of clause 51 or clause 52, wherein the alkanolamine is represented by the formula NH₂—Z—OH, in which Z represents a divalent radical which is a straight chain or branched chain alkylene radical having 2 to 6 carbon atoms, a cycloalkylene radical having 4 to 6 carbon atoms or a dialkylene ether radical having 4 to 6 carbon atoms, such as where the dialkylene ether radical is be represented by the formula —R—O—R— in which each R represents a hydrocarbon radical having 2 to 3 carbon atoms.

Clause 54. The isocyanate-reactive composition of one of clause 51 to clause 53, wherein the alkanolamine used to prepare the alkanolamine-initiated polyether polyol comprises monoethanolamine, 1-amino-2-propanol, 2-amino-1-propanol, 3-amino-1-propanol, 1-(2-aminoethoxy) ethanol, 1-amino-2-butanol, 2-amino-3-butanol, 2-amino-2-methylpropanol, 5-amino pentanol, 3-amino-2, 2-dimethyl propanol, 4-aminocyclohexanol, or a mixture of any two or more thereof.

Clause 55. The isocyanate-reactive composition of one of clause 51 to clause 54, wherein the alkylene oxide used to prepare the alkanolamine-initiated polyether polyol comprises propylene oxide in an amount of at least 80% by weight, at least 90% by weight, at least 95% by weight, or 100% by weight, based on the total weight of alkylene oxide used to prepare the alkanolamine-initiated polyether polyol.

Clause 56. The isocyanate-reactive composition of one of clause 51 to clause 55, wherein the alkanolamine-initiated polyether polyol has an OH number of 500 to 900 mg KOH/g polyol, 600 to 800 mg KOH/g polyol, or 680 to 720 mg KOH/g polyol, and/or a functionality of 2.5 to 3.5.

Clause 57. The isocyanate-reactive composition of one of clause 51 to clause 56, wherein the alkanolamine-initiated polyether polyol is present in an amount of 5 to 20% by weight, 10 to 20% by weight, or 10 to 15% by weight, based upon the total weight of the polyol blend.

Clause 58. The isocyanate-reactive composition of one of clause 51 to clause 57, wherein the polyol blend further comprises a saccharide-initiated polyether polyol that is different from the previously described alkanolamine-initiated polyether polyol.

Clause 59. The isocyanate-reactive composition of clause 58, wherein saccharide is present in an amount of at least 50% by weight or 50 to 90% by weight, based on the total weight of H-functional initiator used to prepare the saccharide-initiated polyether polyol.

Clause 60. The isocyanate-reactive composition of clause 58 or clause 59, wherein the saccharide comprises sucrose, sorbitol, maltitol, or a mixture of any two or more thereof, such as water, propylene glycol, glycerin, ethylene glycol, an ethanol amine, diethylene glycol, or a mixture of any two or more thereof, is present as a co-initiator with the saccharide to produce the saccharide-initiated polyether polyol.

Clause 61. The isocyanate-reactive composition of one of clause 58 to clause 60, wherein the alkylene oxide used to produce the saccharide-initiated polyether polyol comprises ethylene oxide, propylene oxide, butylene oxide, styrene oxide, epichlorohydrin, or a mixture of any two or more thereof, such as where (1) the alkylene oxide comprises propylene oxide in an amount of greater than 80% by weight, at least 90% by weight, or at least 95% by weight, based on the total weight of alkylene oxide used to prepare the saccharide-initiated polyether polyol, or (2) where the alkylene oxide comprises propylene oxide in an amount of 50 to 80% by weight, such as 60 to 80% by weight or 65 to 75% by weight, based on the total weight of alkylene oxide used to prepare the saccharide-initiated polyether polyol, and ethylene oxide in used in an amount of 10 to 50% by weight, such as 20 to 40% by weight, or 25 to 35% by weight, based on the total weight of alkylene oxide used to prepare the saccharide-initiated polyether polyol.

Clause 62. The isocyanate-reactive composition of one of clause 58 to clause 61, wherein the saccharide-initiated polyether polyol comprises: (i) a first saccharide-initiated polyether polyol in which propylene oxide is used in an amount of greater than 80% by weight, at least 90% by weight, or, in some cases, at least 95% by weight, or 100% by weight, based on the total weight of alkylene oxide used to prepare the first saccharide-initiated polyether polyol, and (ii) a second saccharide-initiated polyether polyol in which propylene oxide is used in an amount of 50 to 80% by weight, 60 to 80% by weight, or 65 to 75% by weight, based on the total weight of alkylene oxide used to prepare the second saccharide-initiated polyether polyol, and ethylene oxide in used in an amount of 10 to 50% by weight, 20 to 40% by weight, or 25 to 35% by weight, based on the total weight of alkylene oxide used to prepare the second saccharide-initiated polyether polyol.

Clause 63. The isocyanate-reactive composition of one of clause 58 to clause 62, wherein the saccharide-initiated polyether polyol has an OH number of 200 to 600 mg KOH/g polyol, 300 to 550 mg KOH/g polyol, or 400 to 500 mg KOH/g polyol, and a functionality of 4 to 6, such as where the saccharide-initiated polyether polyol comprises: (i) the first saccharide-initiated polyether polyol described in clause 12 that has an OH number of 200 to 600 mg KOH/g polyol, 300 to 500 mg KOH/g polyol, or 400 to 450 mg KOH/g polyol, and a functionality of 4 to 6, 4 to 5, or 4.0 to 4.5, and (ii) the second saccharide-initiated polyether polyol described in clause 12 that has an OH number of 200 to 600 mg KOH/g polyol, 300 to 500 mg KOH/g polyol, or greater than 450 to 500 mg KOH/g polyol, and a functionality of 4 to 6, 5 to 6, or 5.2 to 5.8.

Clause 64. The isocyanate-reactive composition of one of clause 58 to clause 63, wherein the saccharide-initiated polyether polyol is present in an amount of 50 to 90% by weight, 60 to 80% by weight, or 65 to 75% by weight, based on the total weight of the polyol blend, such as where the saccharide-initiated polyether polyol comprises: (i) the first saccharide-initiated polyether polyol described in clause 12 that is present in an amount of 10 to 40% by weight or 20 to 30% by weight, based on total weight of the polyol blend, and (ii) the second saccharide-initiated polyether polyol described in clause 12 that is present in amount of 30 to 80% by weight, 30 to 60% by weight, 30 to 50% by weight, or 40 to 50% by weight, based on total weight of the polyol blend.

Clause 65. The isocyanate-reactive composition of one of clause 62 to clause 64, wherein the second saccharide-initiated polyether polyol and the first saccharide-initiated polyether polyol are present in a relative ratio, by weight, of 1:1 to 3:1, 1:1 to 2:1, or 1.5:1 to 2:1.

Clause 66. The isocyanate-reactive composition of one of clause 58 to clause 65, wherein the saccharide-initiated polyether polyol and the alkanolamine-initiated polyether polyol are present in the polyol blend at a weight ratio of at least 1:1, 1:1 to 10:1, or 2:1 to 8:1; 4:1 to 8:1 or 5:1 to 6:1.

Clause 67. The isocyanate-reactive composition of one of clause 51 to clause 66, wherein the polyol blend further comprises an aliphatic triol-initiated polyether polyol that is different from the alkanolamine-initiated polyether polyol and the saccharide-initiated polyether polyol.

Clause 68. The isocyanate-reactive composition of clause 67, wherein aliphatic triol is present in an amount of 50% to 100% by weight, 80 to 100% by weight, 90 to 100% by weight, or 100% by weight, based on the total weight of H-functional initiator used to prepare the aliphatic triol-initiated polyether polyol.

Clause 69. The isocyanate-reactive composition of clause 67 or clause 68, wherein the aliphatic triol comprises glycerin, wherein the glycerin is optionally used in combination a saccharide, water, propylene glycol, ethylene glycol, an ethanol amine, diethylene glycol, or a mixture of any two or more thereof.

Clause 70. The isocyanate-reactive composition of one of clause 67 to clause 69, wherein propylene oxide is present in an amount of greater than 80% by weight, at least 90% by weight, at least 95% by weight, or 100% by weight, based on the total weight of alkylene oxide used to prepare the aliphatic triol-initiated polyether polyol.

Clause 71. The isocyanate-reactive composition of one of clause 67 to clause 70, wherein the aliphatic triol-initiated polyether polyol has a hydroxyl number of 200 to 800 mg KOH/g polyol, 300 to 600 mg KOH/g polyol, 400 to 500 mg KOH/g polyol, or 450 to 500 mg KOH/g polyol, and/or a functionality of greater than 2 to less than 4, 2.5 to 3.5, or 3.0.

Clause 72. The isocyanate-reactive composition of one of clause 67 to clause 71, wherein the aliphatic triol-initiated polyether polyol is present in an amount of 10 to 50% by weight, 10 to 40% by weight, 10 to 30% by weight, or 15 to 25% by weight, based on the total weight of the polyol blend.

Clause 73. The isocyanate-reactive composition of one of clause 67 to clause 72, wherein the polyol blend comprises both the saccharide-initiated polyether polyol and the aliphatic triol-initiated polyether polyol, in which the saccharide-initiated polyether polyol and aliphatic triol-initiated polyether polyol are present in the polyol blend in a weight ratio of 1:10 to 10:1, 1:1 to 10:1, 1:1 to 5:1, or 2:1 to 4:1.

Clause 74. The isocyanate-reactive composition of one of clause 67 to clause 73, wherein the aliphatic triol-initiated polyether polyol and alkanolamine-initiated polyether polyol are present in the polyol blend at a weight ratio of at least 1:1, 1:1 to 10:1, or 1:1 to 5:1; 1:1 to 2:1 or 1.2:1 to 1.8.1.

Clause 75. The isocyanate-reactive composition of one of clause 51 to clause 74, wherein the isocyanate-reactive composition is substantially free, or completely free, of one or more of (i) aromatic amine-initiated polyether polyol, (ii) polyester polyol, (iii) aliphatic polyamine-initiated polyether polyols, (iv) polyoxyalkylene glycol; and (v) polymer polyol.

Clause 76. The isocyanate-reactive composition of one of clause 51 to clause 75, wherein the sum of the amount of the alkanolamine-initiated polyether polyol, saccharide-initiated polyether polyol, and aliphatic triol-initiated polyether polyol in the polyol blend is 90 to 100% by weight, 95 to 100% by weight, 99 to 100% by weight, or 99.9 to 100% by weight, based on the total weight of the polyol blend.

Clause 77. The isocyanate-reactive composition of one of clause 51 to clause 76, wherein the polyol blend has a weighted average functionality of 3 to 6, 3 to 5 or 3 to 4, and/or a weighted average hydroxyl number of 300 to 600 mg KOH/g polyol, 400 to 500 mg KOH/g polyol, or 450 to 500 mg KOH/g polyol, and/or a weighted average molecular weight of 200 to 800 g/mol, 200 to 600 g/mol or 400 to 500 g/mol.

Clause 78. The isocyanate-reactive composition of one of clause 51 to clause 77, wherein the polyol blend has a content of —C₂H₄O— units of 3 to 14% by weight, 4 to 13% by weight, 5 to 12% by weight, 6 to 11% by weight, 7 to 10% by weight, 7 to 9% by weight, or 7 to 8% by weight, based on the total weight of the isocyanate-reactive composition.

Clause 79. The isocyanate-reactive composition of one of clause 51 to clause 78, wherein the HCFO comprises 1-chloro-3,3,3-trifluoropropene (HCFO-1233zd, E and/or Z isomers), 2-chloro-3,3,3-trifluoropropene (HCFO-1233xf), HCFO1223, 1,2-dichloro-1,2-difluoroethene (E and/or Z isomers), 3,3-dichloro-3-fluoropropene, 2-chloro-1,1,1,4,4,4-hexafluorobutene-2 (E and/or Z isomers), and 2-chloro-1,1,1,3,4,4,4-heptafluorobutene-2 (E and/or Z isomers), or a mixture of any two or more thereof.

Clause 80. The isocyanate-reactive composition of one of clause 51 to clause 79, wherein the HCFO is present in an amount of at least 1% by weight, such as 5 to 30% by weight, 5 to 20% by weight, 5 to 15% by weight, 10 to 15% by weight, 4 to less than 12% by weight, 8 to less than 12% by weight or 9 to 110% by weight, based on the total weight of the polyol blend.

Clause 81. The isocyanate-reactive composition of one of clause 51 to clause 80, wherein the isocyanate-reactive composition is substantially or completely free of other physical blowing agents, such as other halogenated blowing agents, such as CFCs, HCFCs, and/or HFCs and/or hydrocarbon blowing agents.

Clause 82. The isocyanate-reactive composition of one of clause 51 to clause 81, wherein the chemical blowing agent, such as water, is present in an amount of 0.5 to 10.0% by weight, 2 to 8% by weight, 3.0 to 7.0% by weight, or 4.0 to 6.0% by weight, based on the total weight of the polyol blend.

Clause 83. The isocyanate-reactive composition of one of clause 51 to clause 82, wherein the HCFO and the carbon dioxide generating chemical blowing agent are present in an amount of at least 90% by weight, at least 95% by weight, at least 99% by weight, or 100% by weight, based on the total weight of the blowing agent composition.

Clause 84. The isocyanate-reactive composition of one of clause 51 to clause 83, wherein the HCFO and a carbon dioxide generating chemical blowing agent are present in the blowing agent composition at a weight ratio of at least 2:1, such as 2:1 to 10:1, 2:1 to 4:1, 1:1 to 3:1, 2:1 to 3:1, or 2.0:1 to 2.5:1.

Clause 85. The isocyanate-reactive composition of one of clause 51 to clause 84, wherein the arylalkyl tertiary amine, an aryl tertiary amine, or a mixture thereof comprises a N,N-dialkylbenzylamine, such as those where each alkyl group of the N,N-dialkylbenzylamine independently contains 1 to 6 carbon atoms, such as N, N-dimethylbenzylamine (CAS No. 103-83-3) or N,N-diethylbenzylamine; dibenzylethylamine; N,N-dimethylaniline; N,N-diethylaniline; N-methyl-N-ethylaniline; N,N-diisopropylaniline; or a mixture of any two or more thereof.

Clause 86. The isocyanate-reactive composition of clause 51 or clause 85, wherein the arylalkyl tertiary amine, an aryl tertiary amine, or a mixture thereof is present in an amount of 0.2 to 0.9%, 0.4 to 0.8% by weight, or 0.6 to 0.7% by weight, based on the total weight of the polyol blend.

Clause 87. The isocyanate-reactive composition of one of clause 51 to clause 86, wherein the catalyst composition further comprises a blow catalyst comprising a morpholine, such as dimorpholinodiethylether, dimorpholinodimethylether, N-ethylmorpholine, N-methylmorpholine, or a mixture of any two or more thereof.

Clause 88. The isocyanate-reactive composition of clause 87, wherein the blow catalyst and the arylalkyl tertiary amine, an aryl tertiary amine, or a mixture thereof are present in a relative ratio, by weight, of at least 1:1, 1:1 to 10:1, 1:1 to 3:1, 2:1 to 8:1, or 3:1 to 6:1.

Clause 89. The isocyanate-reactive composition of one of clause 51 to clause 88, wherein the catalyst composition comprises: (i) 50 to 90% by weight, such as 60 to 80% by weight, or, in some cases, 85 to 90% by weight, based on the total weight of the catalyst composition, of a blow catalyst, such as a morpholine; and (ii) 10 to 50% by weight, such as 20 to 40% by weight, or, in some cases, 10 to 15%% by weight, based on the total weight of the catalyst composition, of a arylalkyl tertiary amine, an aryl tertiary amine, or a mixture thereof.

Clause 90. The isocyanate-reactive composition of one of clause 51 to clause 89, wherein the catalyst composition does not include an acid-blocked amine catalyst.

Clause 91. The isocyanate-reactive composition of one of clause 51 to clause 90, wherein the isocyanate-reactive composition does not include a metal catalyst and/or any other catalyst that is not a tertiary amine catalyst.

Clause 92. The isocyanate-reactive composition of one of clause 51 to clause 91, wherein the catalyst composition is present in an amount of 1 to 10% by weight, 4.0 to 8.0% or 5.0 to 7.0% by weight, based on the total weight of the polyol blend.

Clause 93. A polyurethane foam-forming compositions comprising: (a) a polyisocyanate; and (b) the isocyanate-reactive composition of one of clause 51 to clause 92, such as where the polyurethane foam-forming composition has an isocyanate index of 0.90 to 1.80, 0.90 to 1.50, 0.90 to 1.40, or 1.00 to 1.20.

Clause 94. The polyurethane foam-forming composition of clause 93, wherein the polyurethane foam-forming composition has a content of —C₂H₄O— units of 1 to 5% by weight, 1 to 4% by weight, 1 to 3% by weight, 1.5 to 3% by weight, or 1.5 to 2.5% by weight, based on the total weight of the polyurethane foam-forming composition.

Clause 95. The polyurethane foam-forming composition of clause 93 or clause 94, wherein the polyisocyanate comprises a methylene-bridged polyphenyl polyisocyanate and/or a prepolymer of methylene-bridged polyphenyl polyisocyanates having an average functionality of 1.8 to 3.5 or 2.0 to 3.1 isocyanate moieties per molecule and an NCO content of 25 to 32 weight percent.

Clause 96. A polyurethane foam formed from the polyurethane foam-forming composition of one of clause 93 to clause 95.

Clause 97. The polyurethane foam of clause 96, wherein the polyurethane foam has more than 80 percent, more than 85 percent, or more than 88 percent closed-cell content as measured according to ASTM D6226-15 and/or a thermal conductivity, measured at 35° F. (2° C.), of less than 0.160 BTU-in/h-ft2-° F. for foam from the core of 2-inch thick panels, as measured according to ASTM C518-17.

Clause 98. A composite article comprising a polyurethane foam core comprising the polyurethane foam of clause 96 or clause 97, wherein the polyurethane foam core includes a first face that is adhered to a first substrate and a second face that is adhered to a second substrate, such as where the composite article comprises an entry door.

Clause 99. The composite article of clause 98, wherein the first substrate and/or the second substrate is made of plastic (such a polypropylene resin reinforced with continuous bi-directional glass fibers or a fiberglass reinforced polyester copolymer), paper, wood, or metal, such as steel or aluminum, such as where the first substrate and the second substrate comprise a sheet of metal, such as steel, having a thickness of 0.021 inch to 0.027 inch (0.53 millimeter to 0.69 millimeter).

The non-limiting and non-exhaustive examples that follow are intended to further describe various non-limiting and non-exhaustive embodiments without restricting the scope of the embodiments described in this specification.

### EXAMPLES

Foam-forming compositions were prepared using the ingredients and amounts (in parts by weight) set forth in the Table below. The following materials were used:
POLYOL 1: a glycerin-initiated propylene oxide-based (100% propylene oxide as the alkylene oxide)triol having an OH number of 445-495 mg KOH/g;
POLYOL 2: a sucrose/glycerin/propylene glycol/water-initiated polyether polyol (100% propylene oxide as the alkylene oxide) having an OH number of 390-430 mg KOH/g and a functionality of 4.28;
POLYOL 3: a monoethanolamine-initiated polyether polyol having an OH number of 685 to 715, a functionality of 3, prepared by propoxylating (100% propylene oxide as the alkylene oxide) monoethanolamine;
POLYOL 4: a sucrose/water-initiated polyether polyol (30 wt % ethylene oxide and 70 wt % propylene oxide as the alkylene oxide) having an OH number of 450-490 mg KOH/g and a functionality of 5.52;
SURFACTANT: TEGOSTAB B-8465 commercially available from Evonik;
CATALYST 1: 2,2′-dimorpholinodiethylether (JEFFCAT® DMDEE from Huntsman);
CATALYST 2: N,N-benzyldimethylamine (ADDOCAT® DB from Lanxess); HCFO: trans-1-Chloro-3,3,3-trifluoropropene (Solstice® LBA from Honeywell); and
ISO: polymeric diphenylmethane diisocyanate (pMDI); NCO weight 31.5%; viscosity 200 mPa-s @25° C.; equivalent weight 133; functionality 2.8 (MONDUR® MR from Covestro).

In each case, a masterbatch was prepared by mixing the polyols, catalysts, surfactant, water, and blowing agents in the amounts indicated in Table 1. Foams were prepared by mixing, via air driven hand mixer, the masterbatch with the amount of isocyanate indicated in Table 1 for 5 seconds and pouring the mixture into an 83 ounce paper cup. The individual liquids were maintained at 10° C. prior to mixing. The cream time, gel time, and free rise density (FRD) were recorded and noted in Table 1. Reported results represent the average results of three replicate experiments.

The isocyanate and masterbatch mixture was also poured into a 25 inch×13 inch×2 inch metal mold, containing steel facer material, heated to 49° C. The foam was allowed to react within the metal mold for 5 minutes before removing. Composite panels were produced at 10% overpack of a minimum fill panel. The resultant composite panel was then cut into 12 inch×3 inch sections for 90 degree peel adhesion testing per ASTM D429-14, Method B and 2 inch×2 inch sections for tensile adhesion measurements according to ASTM D1623-17, Type C. Thermal conductivity was measured for foam from the core of 2-inch thick panels, according to ASTM C518-17. Flow was evaluated as described in U.S. Pat. No. 10,106,641 (at col. 12, lines 22-61, the cited portion of which being incorporated herein by reference). Additionally, a pressure transducer was located 10 cm above the protruding sheet metal based edge, which recorded the foaming pressure during the process. Results are set forth in Table 1.

In Table 1, Examples 2-6 are the inventive examples. As is apparent, foams of Examples 2-4 exhibited superior thermal insulation properties to the foam of Example 1, whereas the foams of Examples 5-6 exhibit thermal insulation properties similar to that of Example 1 at reduced HCFO content relative to Example 1.

TABLE 1

| | Example 1 | Example 2 | Example 3 | Example 4 | Example 5 | Example 6 |
|---|---|---|---|---|---|---|
| POLYOL 1 | 35 | 15 | 15.17 | 15.92 | 18.2 | 23.2 |
| POLYOL 2 | 35 | 20 | 20.17 | 20.92 | 23 | 28 |
| POLYOL 3 | 10 | 10 | 10.17 | 10 | 10 | 10 |
| POLYOL 4 | 0 | 35 | 35.17 | 35.92 | 30 | 20 |
| SURFACTANT | 2 | 2 | 2 | 2 | 2 | 2 |
| CATALYST 1 | 3 | 3 | 3 | 3 | 3 | 3 |
| CATALYST 2 | 1.5 | 1.5 | 1.5 | 0.5 | 1 | 1 |
| Water | 3.6 | 3.6 | 3.82 | 3.74 | 3.8 | 3.8 |
| HCFO | 9.9 | 9.9 | 9 | 8 | 9 | 9 |
| Total parts | 100 | 100 | 100 | 100 | 100 | 100 |
| ISO | 156 | 156 | 156 | 156 | 156 | 156 |
| Index | 1.09 | 1.07 | 1.04 | 1.04 | 1.04 | 1.05 |
| Resin EO | 0.0% | 7.4% | 7.4% | 7.6% | 6.3% | 4.2% |
| content % | | | | | | |
| System EO | 0.0% | 2.9% | 2.9% | 3.0% | 2.4% | 1.6% |
| content % | | | | | | |
| Resin HCFO | 9.9 | 9.9 | 9 | 8 | 9 | 9 |
| content % | | | | | | |
| System HCFO | 3.9 | 3.9 | 3.5 | 3.1 | 3.5 | 3.5 |
| content % | | | | | | |
| Polyol OH# | 473 | 484 | 484 | 483 | 481 | 478 |
| Mc | 125 | 121 | 121 | 121 | 121 | 123 |
| Polyol MW | 446 | 534 | 533 | 534 | 521 | 498 |
| Polyol Visc | 1204 | 4631 | 4604 | 4583 | 3,784 | 2637 |
| Polyol f | 3.6 | 4.4 | 4.4 | 4.4 | 4.3 | 4.1 |
| OH# | 604 | 613 | 630 | 634 | 630 | 627 |
| blow (mL) | 24.15 | 24.14 | 24.62 | 23.54 | 25 | 24.47 |

RESULTS

| | | | | | | |
|---|---|---|---|---|---|---|
| Cream, (sec) | 16 | 18 | 14 | 16 | 17 | 18 |
| Top of Cup, (sec) | 49 | 52 | 39 | 52 | 60 | 57 |
| Gel Time, (sec) | 98 | 90 | 82 | 101 | 99 | 109 |
| Bucket FRD, (pcf) | 1.68 | 1.64 | 1.43 | 1.52 | 1.6 | 1.6 |
| Adjusted Height | 115.86 | 115.57 | 107.96 | 103.57 | 105.4 | 107.56 |
| @ Gel, cm | | | | | | |
| Adjusted End | 117.44 | 117.72 | 109.47 | 105.78 | 106.71 | 109.4 |
| Height, cm | | | | | | |
| Hg/He | 0.99 | 0.98 | 0.99 | 0.98 | 0.99 | 0.98 |
| Max Rise Rate, | 2.01 | 2.41 | 2.53 | 1.72 | 1.72 | 1.68 |
| mm/sec | | | | | | |
| Max Pressure, hPa | 114.34 | 196.21 | 207.56 | 183.87 | 125.53 | 103.97 |
| k-Factor, 35° F. | 0.141 | 0.134 | 0.134 | 0.136 | 0.14 | 0.144 |
| k-Factor, 75° F. | 0.162 | 0.154 | 0.153 | 0.156 | 0.16 | 0.164 |
| Apparent Density, | 1.76 | 1.71 | 1.72 | 1.75 | 1.75 | 1.74 |
| pcf | | | | | | |
| % Closed Cells | 89.7 | 88.4 | 88.6 | 87.3 | 88.2 | 87.2 |
| 90° Peel Adhesion | 1.755 | 0.775 | 0.98 | Not tested | 0.94 | 1.295 |
| Tensile Adhesion | 22.72 | 8.567 | 11.57 | Not tested | 10.15 | 15.18 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An isocyanate-reactive composition comprising:
(a) a polyol blend comprising 1 to 20% by weight, based on total weight of the polyol blend, of an alkanolamine-initiated polyether polyol having an OH number of at least 500 mg KOH/g polyol and a functionality of 2.5 to 4,
wherein the polyol blend has a content of —C₂H₄O— units of 2 to 15% by weight, based on total weight of the isocyanate-reactive composition;
(b) a blowing agent composition comprising:
(1) a physical blowing agent; and
(2) a carbon dioxide-generating chemical blowing agent; and
(c) a catalyst composition comprising a tertiary amine, wherein
(i) the carbon dioxide-generating chemical blowing agent is present in an amount of 3 to 6% by weight, based on total weight of the polyol blend,
(ii) the physical blowing agent comprises a hydrochlorofluoroolefin that is present in an amount of 4 to less than 12% by weight, based on total weight of the polyol blend, and in an amount of at least 80% by weight, based on total weight of the physical blowing agent present in the blowing agent composition, and
(iii) the physical blowing agent and the carbon dioxide-generating chemical blowing agent are present in a relative ratio, by weight, of 1:1 to 3:1.

2. The isocyanate-reactive composition of claim 1, wherein the alkanolamine-initiated polyether polyol has an OH number of 600 to 800 mg KOH/g polyol.

3. The isocyanate-reactive composition of claim 1, wherein the polyol blend further comprises a saccharide-initiated polyether polyol that is different from the alkanolamine-initiated polyether polyol.

4. The isocyanate-reactive composition of claim 3, wherein the saccharide-initiated polyether polyol comprises:
(i) a first saccharide-initiated polyether polyol in which propylene oxide is used in an amount of at least 90% by weight, based on total weight of alkylene oxide used to prepare the first saccharide-initiated polyether polyol, and
(ii) a second saccharide-initiated polyether polyol in which propylene oxide is used in an amount of 50 to 80% by weight, based on total weight of alkylene oxide used to prepare the second saccharide-initiated polyether polyol, and ethylene oxide is used in an amount of 20 to 50% by weight, based on total weight of alkylene oxide used to prepare the second saccharide-initiated polyether polyol.

5. The isocyanate-reactive composition of claim 4, wherein:
(i) the first saccharide-initiated polyether polyol has an OH number of 400 to 450 mg KOH/g polyol and a functionality 4.0 to 4.5, and
(ii) the second saccharide-initiated polyether polyol has an OH number of greater than 450 to 500 mg KOH/g polyol and a functionality of 5.2 to 5.8.

6. The isocyanate-reactive composition of claim 3, wherein the saccharide-initiated polyether polyol is present in an amount of 50 to 90% by weight, based on total weight of the polyol blend.

7. The isocyanate-reactive composition of claim 3, wherein the polyol blend further comprises an aliphatic triol-initiated polyether polyol that is different from the alkanolamine-initiated polyether polyol and the saccharide-initiated polyether polyol, wherein aliphatic triol is present in an amount of 80 to 100% by weight, based on total weight of H-functional initiator used to prepare the aliphatic triol-initiated polyether polyol.

8. The isocyanate-reactive composition of claim 7, wherein propylene oxide is present in an amount of at least 90% by weight, based on total weight of alkylene oxide used to prepare the aliphatic triol-initiated polyether polyol.

9. The isocyanate-reactive composition of claim 8, wherein the aliphatic triol-initiated polyether polyol has a hydroxyl number of 300 to 600 mg KOH/g polyol.

10. The isocyanate-reactive composition of claim 8, wherein the aliphatic triol-initiated polyether polyol is present in an amount of 10 to 30% by weight, based on total weight of the polyol blend.

11. The isocyanate-reactive composition of claim 1, wherein the polyol blend has a content of —C₂H₄O— units of 7 to 9% by weight, based on total weight of the isocyanate-reactive composition.

12. The isocyanate-reactive composition of claim 1, wherein tertiary amine comprises an arylalkyl tertiary amine, an aryl tertiary amine, or a mixture thereof.

13. The isocyanate-reactive composition of claim 12, wherein the arylalkyl tertiary amine, an aryl tertiary amine, or a mixture thereof is present in an amount of 0.1 to less than 1.0% by weight, based on total weight of the polyol blend.

14. The isocyanate-reactive composition of claim 12, wherein the arylalkyl tertiary amine, an aryl tertiary amine, or a mixture thereof is present in an amount of 0.2 to 0.9%, based on total weight of the polyol blend.

15. The isocyanate-reactive composition of claim 12, wherein the arylalkyl tertiary amine, an aryl tertiary amine, or a mixture thereof is present in an amount of 0.4 to 0.8% by weight, based on total weight of the polyol blend.

16. A polyurethane foam-forming compositions comprising:
(a) a polyisocyanate; and
(b) the isocyanate-reactive composition of claim 1.

17. The polyurethane foam-forming composition of claim 16, wherein the polyurethane foam-forming composition has a content of —C₂H₄O— units of 1.5 to 2.5% by weight, based on total weight of the polyurethane foam-forming composition.

18. A polyurethane foam formed from the polyurethane foam-forming composition of claim 16.

19. A composite article comprising a polyurethane foam core comprising the polyurethane foam of claim 18, wherein the polyurethane foam core includes a first face that is adhered to a first substrate and a second face that is adhered to a second substrate

20. An isocyanate-reactive composition comprising:
(a) a polyol blend comprising 1 to 20% by weight, based on total weight of the polyol blend, of an alkanolamine-initiated polyether polyol having an OH number of at least 500 mg KOH/g polyol and a functionality of 2.5 to 4,
wherein the polyol blend has a content of —C₂H₄O— units of 2 to 15% by weight, based on total weight of the isocyanate-reactive composition;
(b) a blowing agent composition comprising:
(1) a hydrochlorofluoroolefin; and
(2) a carbon dioxide-generating chemical blowing agent; and
(c) a catalyst composition comprising an arylalkyl tertiary amine, an aryl tertiary amine, or a mixture thereof that is present in an amount of 0.1 to less than 1.0% by weight, based on total weight of the polyol blend.
